(19) United States
(12) Patent Application Publication
(10) Pub. No.: US 2018/0203809 A1
(43) Pub. Date: Jul. 19, 2018

(54) INTERMEDIATE MODULE FOR CONTROLLING COMMUNICATION BETWEEN A DATA PROCESSING DEVICE AND A PERIPHERAL DEVICE

(71) Applicant: DEUTSCHE TELEKOM AG, Bonn (DE)

(72) Inventor: Jens WAGNER, Leipzig (DE)

(73) Assignee: DEUTSCHE TELEKOM AG, Bonn (DE)

(21) Appl. No.: 15/744,242

(22) PCT Filed: Jul. 16, 2015
(86) PCT No.: PCT/EP2015/066296

§ 371 Date: Jan. 12, 2018

(51) Int. Cl. G06F 13/10; G06F 13/20; G06F 21/82

(52) U.S. Cl. CPC G06F 13/105; G06F 21/82; G06F 13/20; G06F 13/102

(57) ABSTRACT

An intermediate module for controlling communication between a data processing device and a peripheral device comprises: a first data processing unit having a first communications interface, which can be connected to a communications interface of the peripheral device. The first data processing unit is configured to emulate a functionality of the data processing device and to receive data from the peripheral device via the first communications interface. A second data processing unit having a second communications interface can be connected to a communications interface of the data processing device, and configured to emulate a functionality of the peripheral device and to transfer the receive data to the data processing device. A third data processing is arranged between the first data processing unit and the second data processing unit, and configured to transfer the receive data to the second data processing unit for transfer to the data processing device.

The present invention relates to controlling communication between a data processing device and a peripheral device.

Modern data processing devices are usually equipped with communications interfaces, to which can be connected peripheral devices such as storage devices, in particular USB storage devices, or keyboards. Such peripheral devices can be used for attacks on data processing devices, however. For instance, a peripheral device can be used to make an attempt to install unwanted software on a data processing device.

Protecting data processing devices from unwanted accesses by peripheral devices is possible, for example, by deactivating certain communications interfaces of the data processing devices. Such a measure, however, often can only be implemented with difficulty because of the widespread use and major importance of peripheral devices.

The object of the present invention is to provide a concept for more secure communication between a data processing device and a peripheral device.

This object is achieved by the features of the independent claims. The subject matter of the dependent claims contains advantageous developments.

The invention is based on the finding that the above-mentioned object is achieved by an intermediate module that controls the communication between a data processing device and a peripheral device. This intermediate module comprises communications interfaces for connecting a data processing device and a peripheral device. The intermediate module emulates the functionalities of the data processing device and of the peripheral device in order to simulate to the peripheral device the connection to a data processing device, and/or to simulate to the data processing device the connection of a peripheral device. The intermediate module can control the transfer of receive data from the peripheral device to the data processing device according to a transfer rule, and thereby prevent unwanted data being transferred.

According to a first aspect, the invention relates to an intermediate module for controlling communication between a data processing device and a peripheral device, which module comprises: a first data processing unit having a first communications interface, which is connectable to a communications interface of the peripheral device, wherein the first data processing unit is configured to emulate a functionality of the data processing device and to receive the receive data from the peripheral device via the first communications interface; a second data processing unit having a second communications interface, which is connectable to a communications interface of the data processing device, wherein the first data processing unit is configured to emulate a functionality of the peripheral device and to transfer the receive data to the data processing device; and a third data processing unit, which in terms of communication is arranged between the first data processing unit and the second data processing unit, and is configured to transfer the receive data to the second data processing unit for transfer to the data processing device.

The intermediate module allows the peripheral device to be connected to the data processing device securely. The peripheral device sees the first data processing unit as part of the data processing device, and the data processing device sees the second data processing unit as a peripheral device having a specific functionality. The third data processing unit can be configured to receive receive data, which is sent from the peripheral device to the first data processing unit and is intended for the data processing device, and to transfer this receive data to the second data processing unit. The second data processing unit can provide this transferred data to the data processing device. It is hence possible to ensure that there is no direct connection between the peripheral device and the data processing device. In addition, only a specific functionality of the peripheral device, for instance a memory function, can be emulated in the second data processing unit. An unwanted access attempt by a compromised peripheral device, for instance a mass storage device, which declares itself to the data processing device as a keyboard without being noticed in order to make inputs, can hence be prevented because, by virtue of the emulated memory function in the second data processing unit, no keyboard inputs are transferred to the data processing device.

Emulation is the mimicking of the behavior of a system by another technical system. In the intermediate module presented here, the second data processing unit and the first data processing unit respectively mimic functionalities of the peripheral device and of the data processing device.

The intermediate module can comprise a memory and/or a processor in order to ensure operation of the first data processing unit, the second data processing unit and the third data processing unit. The memory may be a flash memory. Data from the peripheral device can be stored temporarily in the memory in order to provide this data to the data processing device. The processor may be a microprocessor.

In an embodiment of the intermediate module, the third data processing unit is configured to check the receive data with regard to a predefined transfer rule, and to transfer the receive data to the second data processing unit, for transfer to the data processing device, only when the transfer rule is satisfied.

This has the advantage that the data processing device can be protected effectively against unwanted data, for instance unwanted software. The transfer rule can be stored in a memory of the intermediate module, which memory is associated with the third data processing unit.

In an embodiment of the intermediate module, the third data processing unit is configured to transfer, in accordance with the transfer rule, only receive data that comprises files of a specific file type, in particular text files, graphics files or video files, to the second data processing unit for transfer to the data processing device.

This has the advantage that the transmission of unwanted file types on connecting a peripheral device having a memory function, for instance a USB stick, can be prevented. Unwanted file types may be, for example, executable files, for instance EXE files, which are stored in a hidden memory in the USB stick. The USB stick can be configured in such a way that after being connected to a data processing device, it transmits an unwanted file of this type to the data processing device. If the transfer rule of the intermediate module restricts the transmission to specific file types, however, for instance to Word documents, then transmission of the unwanted file to the data processing device can be prevented efficiently.

In an embodiment of the intermediate module, the third data processing unit is configured to transfer, in accordance with the transfer rule, only receive data that comprises a specific content, in particular files having a specific signature, to the second data processing unit for transfer to the data processing device.

This has the advantage that only data having a known and secure content can be transmitted from the peripheral device to the data processing device. This can likewise efficiently prevent transmission of unwanted data to the data processing device.

In an embodiment of the intermediate module, the third data processing unit is configured to control the emulation of the functionality of the data processing device in the first data processing unit and the emulation of the functionality of the peripheral device in the second data processing unit.

This has the advantage that neither the peripheral device nor the data processing device itself can influence the emulation of the functionality of the data processing device or the emulation of the functionality of the peripheral device. For this purpose, the third data processing unit can be configured to be invisible to the peripheral device or to the data processing device.

In an embodiment of the intermediate module, the third data processing unit is configured to permit only the emulation of specific functionalities of the peripheral device, in particular memory functionalities or control functionalities, in the second data processing unit.

This has the advantage that the intermediate module can be configured for peripheral devices having a specific functionality. The intermediate module can be configured for different peripheral devices, for instance storage devices, input devices or output devices. The data processing device can hence be protected efficiently against unwanted additional functionalities of these peripheral devices.

In an embodiment of the intermediate module, the first communications interface and the second communications interface are each one of the following communications interfaces: USB communications interface; PS/2 communications interface; SATA communications interface; HDMI communications interface; DisplayPort communications interface; Ethernet communications interface; Bluetooth communications interface; WLAN communications interface; UMTS communications interface; LTE communications interface.

In an embodiment of the intermediate module, the first communications interface and the second communications interface are each USB interfaces, and the first data processing unit emulates a USB host controller, and the second data processing unit emulates a USB peripheral device.

This has the advantage that the intermediate module can be used for connecting data processing devices securely to USP peripheral devices. The data processing device can hence be protected efficiently against compromised USB peripheral devices, otherwise known as BadUSB devices.

In an embodiment of the intermediate module, the intermediate module comprises a display and/or an operator control in order to display to a user an activity of the intermediate module and/or to make it possible for a user to confirm a transfer of receive data.

The operator control may be at least one pushbutton switch, a numerical keypad, a keyboard or a touchscreen. The display may be at least one indicator light or a screen, for instance an LCD display or a thin-film display.

In an embodiment of the intermediate module, the third data processing unit is connected to the display and/or to the operator control for the purpose of control and/or communication.

This has the advantage that the display and the operator control can be controlled only by the third data processing unit, and that the peripheral device or the data processing device cannot influence the display or simulate actuation of the operator control. It is hence possible to ensure efficient communication between the intermediate module and the user.

In an embodiment of the intermediate module, the third data processing unit is configured to transfer receive data to the second data processing unit after receiving a confirmation signal, in particular an actuation of the operator control or an actuation of an operator control function of a connected peripheral device.

This has the advantage that receive data can be transferred to the data processing device only at a time specified by the user. For example, the user can prevent receive data being transferred during booting of the data processing device by the user not actuating the operator control until the boot process has finished.

In addition, the user can be prompted to actuate on the operator control or on the connected peripheral device a key combination displayed on the display. The user can thereby authorize a transfer of receive data. In addition, by actuating on a connected keyboard a key combination defined by the intermediate module, it is possible to confirm the authenticity of this keyboard.

In an embodiment of the intermediate module, the third data processing unit is configured to transfer receive data to the second data processing unit only in specific time intervals, wherein the time intervals are stored in the third data processing unit.

This has the advantage that it is possible to prevent the peripheral device from influencing the data processing device at a time unknown to the user, for instance outside the working hours of the user. Furthermore, the intermediate module, after connecting to a peripheral device, can transfer the receive data to the data processing device only after a certain period of time. This can ensure that the data processing device has finished booting completely and, for instance, a virus scanner is active before receive data from the peripheral device is transferred.

In an embodiment of the intermediate module, the third data processing unit is configured to transfer the receive data to the second data processing unit, for transfer to the data processing device, according to an operating state of the data processing device.

This has the advantage that it is possible to prevent receive data from the peripheral device being transmitted to the data processing device during an unprotected operating state of the data processing device, for instance while an operating system is booting up.

In an embodiment of the intermediate module, the third data processing unit is configured to transmit a memory of the peripheral device to the second data processing unit, and to prevent further transmission of receive data from the peripheral device to the second data processing unit.

This has the advantage that tampering with data located in a memory of the peripheral device, said tampering being triggered by certain events, can be prevented. For instance this can prevent unwanted software in a hidden memory of the peripheral device becoming visible after a virus scan, or unwanted software in the memory of the peripheral device adapting to an operating system of the data processing device.

In an embodiment of the intermediate module, the intermediate module comprises additional communications interfaces for connecting additional peripheral devices, wherein the additional communications interfaces are connected to the first data processing unit.

This has the advantage that the intermediate module can simultaneously control the communication of a plurality of peripheral devices with the data processing device.

In an embodiment of the intermediate module, the second data processing unit emulates additional functionalities of the additional peripheral devices, and the third data processing unit is configured to transfer additional receive data to the second data processing unit, for transfer to the data processing device, only when the additional receive data satisfies additional transfer rules.

This has the advantage that it is possible to provide efficient protection against the additional peripheral devices compromising the data processing device. The additional peripheral devices can be operated simultaneously via the intermediate module, wherein it is possible to associate each peripheral device with a specific functionality having specific transfer rules.

The additional peripheral devices may be, for example, a USB keyboard, a USB mouse and a USB mass storage device, which can be operated simultaneously.

In an embodiment of the intermediate module, the second data processing unit is configured to receive transmit data from the data processing device via the second communications interface, and the first data processing unit is configured to provide the transmit data to the peripheral device, wherein the third data processing unit transfers the transmit data from the second data processing unit to the first data processing unit for transfer to the peripheral device.

This has the advantage that data can be transmitted from the data processing device to the peripheral device via the intermediate module.

In an embodiment of the intermediate module, the third data processing unit is configured to check the transmit data with regard to a predefined transmit rule, and to transfer the transmit data to the first data processing unit, for transfer to the peripheral device, only when the transmit rule is satisfied.

This has the advantage that the peripheral device can be protected efficiently against the transmission by the data processing device of unwanted data, for instance unwanted software. This can efficiently prevent, for instance, a peripheral device connected to a data processing device being compromised by hidden software on the data processing device.

According to a second aspect, the invention relates to a data processing device for connecting peripheral devices, wherein the intermediate module is integrated in the data processing device.

This has the advantage that a data processing device can be provided that is protected efficiently against unwanted access attempts by connected peripheral devices.

The methods and systems presented can be of various types. The individual elements described can be implemented by hardware or software components, for instance by electronic components which can be produced by various technologies, and include, for example, semiconductor chips, ASICs, microprocessors, digital signal processors, integrated electrical circuits, electro-optic circuits and/or passive components.

The data processing devices presented for connecting the module may be computers, notebooks or smartphones. They may also be servers or industrial controllers. The data processing devices can be connected to other data processing devices to form a computer network.

The peripheral devices presented can be of various types and can have different functions. They can include, amongst other devices, storage devices, input devices or output devices. Possible examples of storage devices are USB sticks, external hard disks or memory cards or memory card readers. Input devices may be, for example, keyboards, mice, touchpads, web cams or microphones, and output devices may be, for example, displays, headphones, loudspeakers, projectors or printers. The peripheral devices may also be other data processing devices, for instance smartphones, MP3 players or notebooks, which can be connected to a data processing device via the intermediate module.

Further exemplary embodiments are described below with reference to the accompanying drawings, in which:

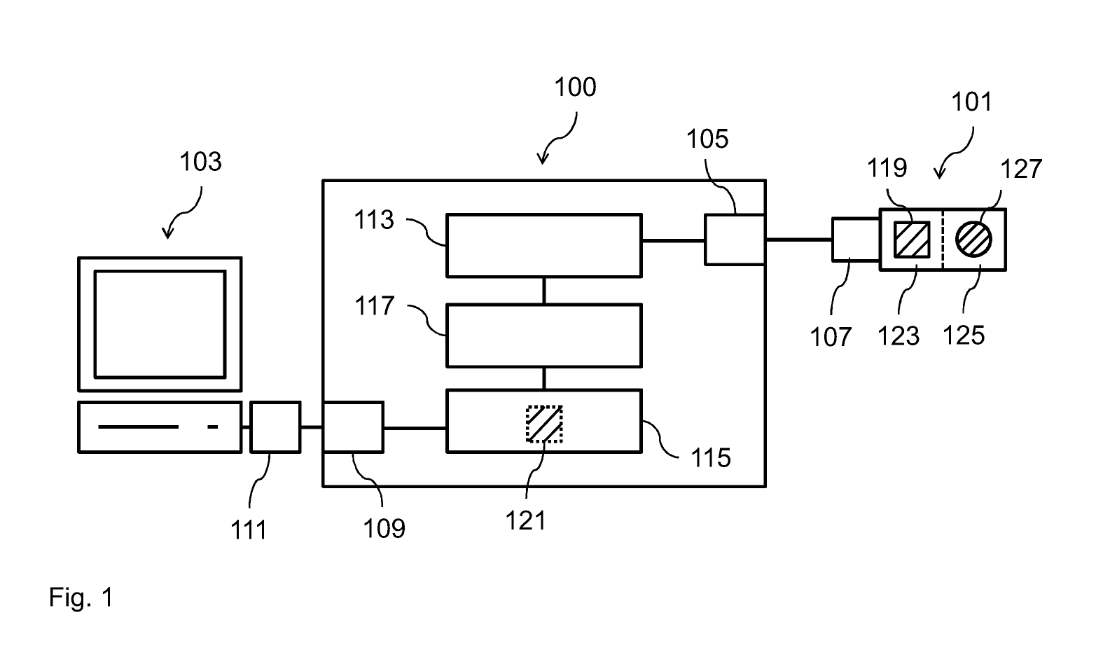

FIG. 1 is a schematic diagram of an intermediate module, which connects a peripheral device to a data processing device;

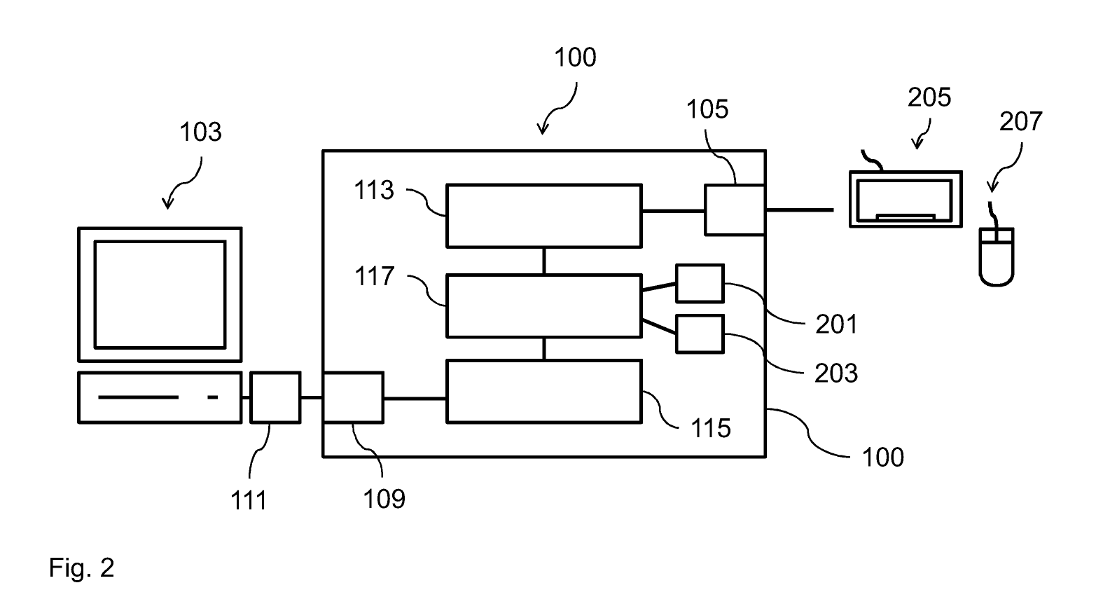

FIG. 2 is a schematic diagram of an intermediate module, which connects input devices to a data processing device; and

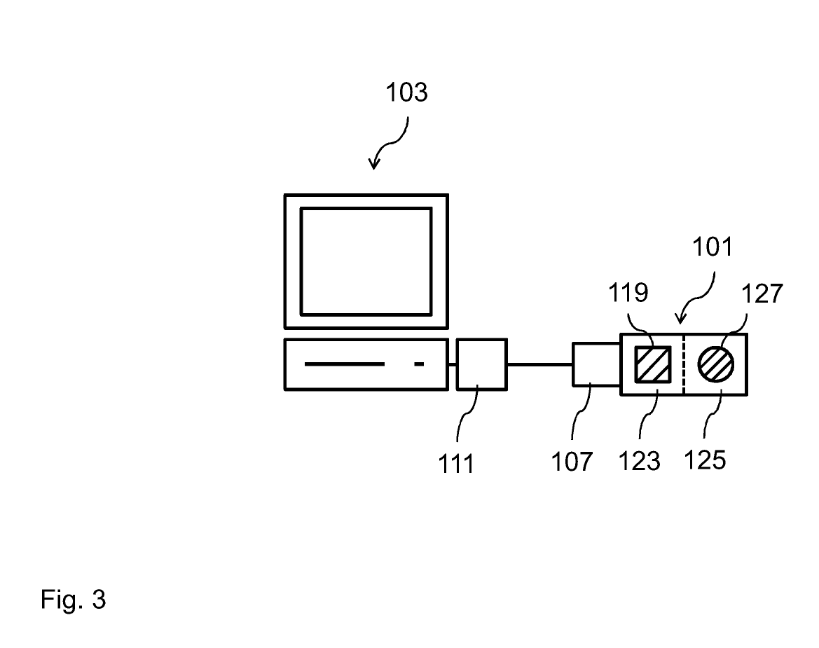

FIG. 3 is a schematic diagram of a peripheral device, which is connected without an intermediate module to a data processing device.

FIG. 1 shows a schematic diagram of an intermediate module 100, which connects a peripheral device 101 to a data processing device 103.

The intermediate module 100 comprises a first communications interface 105, a second communications interface 109, a first data processing unit 113, a second data processing unit 115 containing transferred receive data 121, and a third data processing unit 117. The peripheral device 101 is configured as a storage device and comprises a communications interface 107, a memory 123, which contains data 119, and a hidden memory 125, which contains unwanted data 127. The data processing device 103 comprises a communications interface 111.

The intermediate module 100 is used to control communication between a data processing device 103 and a peripheral device 101.

The first data processing unit 113 is connected to a first communications interface 105, which can be connected to a communications interface 107 of the peripheral device 101, wherein the first data processing unit 113 is configured to emulate a functionality of the data processing device 103, and to receive via the first communications interface 105 receive data from the peripheral device 101.

The second data processing unit 115 is connected to a second communications interface 109, which can be connected to a communications interface 111 of the data processing device 103, wherein the second data processing unit 115 is configured to emulate a functionality of the peripheral device 101, and to transfer the receive data to the data processing device 103.

In terms of communication, the third data processing unit 117 is arranged between the first data processing unit 113 and the second data processing unit 115, and is configured to transfer the receive data to the second data processing unit 115 for transfer to the data processing device 103.

The intermediate module 100 allows the peripheral device 101 to be connected to the data processing device 103 securely. The peripheral device sees the first data processing unit 113 as part of the data processing device 103, and the data processing device 103 sees the second data processing unit 115 as a peripheral device 101 having a specific functionality. The third data processing unit 117 can be configured to receive receive data, which is sent from the peripheral device 101 to the first data processing unit 113 and is intended for the data processing device 103, and to transfer this receive data to the second data processing unit 115. The second data processing unit 115 can provide this transferred data to the data processing device 103. It is hence possible to ensure that there is no direct connection between the peripheral device 101 and the data processing device 103. In addition, only a specific functionality of the peripheral device 101, for instance a memory function, can be emulated in the second data processing unit 115. An unnoticed access attempt by a compromised peripheral device 101, for instance a mass storage device, which without being noticed declares itself to the data processing device as a keyboard in order to make inputs without being noticed, can hence be prevented because, by virtue of the emulated memory function in the second data processing unit 115, no keyboard inputs are transferred to the data processing device 103.

Emulation is the mimicking of the behavior of a system by another technical system. In the intermediate module 100 given here, the second data processing unit 115 and the first data processing unit 113 respectively mimic functionalities of the peripheral device 101 and of the data processing device 103.

The intermediate module 100 can comprise a memory and/or a processor in order to ensure operation of the first data processing unit 113, the second data processing unit 115 and the third data processing unit 117. The memory may be a flash memory. Data 119 from the peripheral device 101 can be stored temporarily in the memory in order to provide this data to the data processing device 103. The processor may be a microprocessor.

The first communications interface 105 and the second communications interface 109 may be configured as USB interfaces, and the first data processing unit 113 can emulate a USB host controller. The intermediate module 100 can hence be used for connecting USB peripheral devices, for instance USB sticks.

The third data processing unit 117 can control the emulation of a functionality of the peripheral device 101 in the second data processing unit 115. This functionality may be, for example, a memory functionality, in particular stored data 119, or a control functionality of the peripheral device 101.

The third data processing unit 117 can apply a transfer rule to the transmission of receive data. This transfer rule can be configured to permit only the transmission of receive data that comprises files of a specific file type or files having a specific content to the first data processing unit 115. The permitted file types may be, for example, text files, graphics files or video files; the files having a specific content may be signed files, for example.

The peripheral device 101 in FIG. 1 is a compromised storage device, for instance a BadUSB device. The compromised storage device contains a public memory 123 containing data 119 for transmission to the data processing device 103, and a hidden memory 125, which contains unwanted data 127.

The third data processing unit 117 in FIG. 1 transfers receive data to the second data processing unit 115 in accordance with the transfer rule. This transferred receive data 121 is provided to the data processing device 103. The data processing device 103 can access only the second data processing unit 115, and hence only the transferred receive data 121 of the storage device, but cannot access the storage device itself. This can hence prevent transmission of the unwanted data 127 to the data processing device 103.

The receive data, which is received from the first data processing unit 113 and transferred to the second data processing unit 115, may be the data 119 in the memory 123 of the peripheral device 101.

The third data processing unit 117 can be configured to permit the transfer of receive data to the second data processing unit 115 only in specific time intervals, which are stored in the third data processing unit 117, or according to an operating state of the data processing unit 103. If the data processing device 103 is a computer, it can thereby be ensured that the boot process of an operating system of the data processing device 103 is completely finished before receive data is transferred, and a virus scanner installed on the data processing device 103 is fully activated.

The third data processing unit 117 can be configured to transmit, after the peripheral device 103 is connected, a memory 123 of the peripheral device 101 in full to the second data processing unit 115, and to provide said memory to the data processing device 103, and to prevent the further transmission of data from the peripheral device 101 into the second data processing unit 115. The memory of the peripheral device 101 may be a visible memory 123, which can be transmitted in full to the second data processing unit 115. The hidden memory 125 is not transmitted. Unwanted data 127, which may be contained in the hidden memory 125, hence cannot access the data processing device 103 or the copy of the memory in the second data processing unit 115.

FIG. 2 shows a schematic diagram of an intermediate module 100, which connects input devices to the data processing device 103.

The intermediate module 100 comprises a first communications interface 105, a second communications interface 109, a first data processing unit 113, a second data processing unit 115, a third data processing unit 117, and a display 201 and an operator control 203. The input devices shown are a keyboard 205 and a mouse 207. The data processing device 103 comprises a communications interface 111.

The third data processing unit 117 can be configured to control the display 201 and the operator control 203. It is thereby possible to prevent the peripheral device 101 or the data processing device 103 from influencing the display 201 or the operator control 203, for instance inhibiting a display signal or simulating an actuation of the operator control 203.

The display 201 can be configured to prompt a user, before receive data, for instance inputs from the keyboard 205 or from the mouse 207, is transferred to the second data processing unit 115, to actuate the operator control 203 or to actuate an operator control function of the connected input device. A user is thereby able to authorize the transfer of receive data by the intermediate module 100 to the data processing device 103.

If, as shown in FIG. 2, the peripheral device 101 is an input device, then the intermediate module 100 can prompt the user to actuate a specific key combination, for instance to press more than one key at once on the keyboard 205 or on the mouse 207. The information about which keys on the input device must be pressed can be stored in the third data processing unit 117. As soon as the first data processing unit 113 registers the actuation of the relevant key combination, the third data processing unit 117 can transmit the receive data from the peripheral device 101 to the second data processing unit 115.

The intermediate module 100 can comprise additional communications interfaces for connecting additional peripheral devices, wherein the additional communications interfaces can be connected to the first data processing unit 113, and wherein the second data processing unit 115 can be configured to emulate additional functionalities in order to operate simultaneously additional peripheral devices having different functionalities. The third data processing unit 117 can be configured to check the receive data from the additional peripheral devices with regard to additional predefined transfer rules, and to transfer the receive data to the second data processing unit, for transfer to the data processing device, only when the additional transfer rules are satisfied. In this case, the third data processing unit can be configured to apply different transfer rules to peripheral devices having different functionalities.

FIG. 3 shows a schematic diagram of a peripheral device 101, which is connected without an intermediate module 100 to a data processing device 103.

The communications interface 111 of the data processing device 103 is connected to the communications interface 107 of the peripheral device 101. Unwanted data 127 in the hidden memory 125 of the peripheral device 101 can be transmitted to the data processing device 103. In addition, the peripheral device 101 in FIG. 3 may be a storage device having a hidden, unwanted functionality, for instance a keyboard function. The data processing device 103 possibly may not recognize this keyboard function as an unwanted functionality. The intermediate module 100, which in FIG. 3 is not used, can protect the data processing device 103 from such unwanted access attempts.

The aspects and embodiments are described with reference to the drawings, where identical elements are in general denoted by identical reference signs. In the description given above, numerous specific details are presented for explanatory purposes in order to give a thorough understanding of one or more aspects of the invention. For a person skilled in the art, however, it may be obvious that one or more aspects or embodiments can be implemented with fewer specific details. In other cases, known structures and elements are shown in schematic form in order to simplify the description of one or more aspects or embodiments. Obviously, other embodiments can be used and structural or logical modifications can be made without departing from the concept of the present invention.

### LIST OF REFERENCES

100 intermediate module
101 peripheral device
103 data processing device
105 first communications interface
107 communications interface of the peripheral device
109 second communications interface
111 communications interface of the data processing device
113 first data processing unit
115 second data processing unit
117 third data processing unit
119 data
121 transferred receive data
123 memory of the peripheral device
125 hidden memory of the peripheral device
127 unwanted data
201 display
203 operator control
205 keyboard
207 mouse

1.-15. (canceled)

16. An intermediate module for controlling communication between a data processing device and a peripheral device, comprising:
a first data processing unit having a first communications interface, which is connectable to a communications interface of the peripheral device, wherein the first data processing unit is configured to emulate a functionality of the data processing device, and to receive via the first communications interface receive data from the peripheral device;
a second data processing unit having a second communications interface, which is connectable to a communications interface of the data processing device, wherein the second data processing unit is configured to emulate a functionality of the peripheral device, and to transfer the receive data to the data processing device; and
a third data processing unit, which in terms of communication is arranged between the first data processing unit and the second data processing unit, and is configured to transfer the receive data to the second data processing unit for transfer to the data processing device.

17. The intermediate module as claimed in claim 16, wherein the third data processing unit is configured to check the receive data with regard to a predefined transfer rule, and to transfer the receive data to the second data processing unit, for transfer to the data processing device, only when the transfer rule is satisfied.

18. The intermediate module as claimed in claim 17, wherein the third data processing unit is configured to transfer, in accordance with the transfer rule, only receive data that comprises files of a specific file type, in particular text files, graphics files or video files, to the second data processing unit for transfer to the data processing device.

19. The intermediate module as claimed in claim 17, wherein the third data processing unit is configured to transfer, in accordance with the transfer rule, only receive data that comprises a specific content, in particular files having a specific signature, to the second data processing unit for transfer to the data processing device.

20. The intermediate module as claimed in claim 16, wherein the third data processing unit is configured to control the emulation of the functionality of the data processing device in the first data processing unit and the emulation of the functionality of the peripheral device in the second data processing unit.

21. The intermediate module as claimed in claim 20, wherein the third data processing unit is configured to permit only the emulation of specific functionalities of the peripheral device, in particular memory functionalities or control functionalities, in the second data processing unit.

22. The intermediate module system as claimed in claim 16, wherein the first communications interface and the second communications interface are each one of the following communications interfaces:
USB communications interface;
PS/2 communications interface;
SATA communications interface;
HDMI communications interface;
DisplayPort communications interface;
Ethernet communications interface;
Bluetooth communications interface;
WLAN communications interface;
UMTS communications interface;
LTE communications interface.

23. The intermediate module as claimed in claim 16, wherein the intermediate module comprises a display and/or an operator control in order to display to a user an activity of the intermediate module and/or to make it possible for a user to confirm a transfer of receive data.

24. The intermediate module as claimed in claim 23, wherein the third data processing unit is connected to the display and/or to the operator control for the purpose of control and/or communication.

25. The intermediate module as claimed in claim 23, wherein the third data processing unit is configured to transfer receive data to the second data processing unit after receiving a confirmation signal, in particular after an actuation of the operator control or an actuation of an operator control function of a connected peripheral device.

26. The intermediate module as claimed in claim 16, where the third data processing unit is configured to transfer receive data to the second data processing unit only in specific time intervals, wherein the time intervals are stored in the third data processing unit.

27. The intermediate module as claimed in claim 16, wherein the third data processing unit is configured to transfer the receive data to the second data processing unit, for transfer to the data processing device, according to an operating state of the data processing device.

28. The intermediate module as claimed in claim 16, wherein the third data processing unit is configured to transmit a memory of the peripheral device to the second data processing unit, and to prevent further transmission of receive data from the peripheral device to the second data processing unit.

29. The intermediate module as claimed in claim 16, wherein the intermediate module comprises additional communications interfaces for connecting additional peripheral devices, wherein the additional communications interfaces are connected to the first data processing unit.

30. A data processing device for connecting peripheral devices, wherein the intermediate module as claimed in claim 16 is integrated in the data processing device.
